(19) United States
(12) Patent Application Publication
(10) Pub. No.: US 2005/0021634 A1
(43) Pub. Date: Jan. 27, 2005

(54) Method and system for passing information between a mobile terminal and predetermined network entities in a hybrid network

(76) Inventors: Ghassan Naim, Garland, TX (US); Jianming Xu, Plano, TX (US); Mahbubul Alam, Dallas, TX (US); Pardeep Kohli, Plano, TX (US); Seshagiri Madhavapeddy, Richardson, TX (US)

Correspondence Address: HAYNES AND BOONE, LLP, 901 MAIN STREET, SUITE 3100, DALLAS, TX, 75202, US

(21) Appl. No.: 10/495,030

(22) PCT Filed: Nov. 21, 2002
(86) PCT No.: PCT/US02/37377

(51) Int. Cl. G06F 15/16

(52) U.S. Cl. 709/206; 709/200

(57) ABSTRACT

The present disclosure provides a method and system for passing information or message contents between a mobile terminal (310 and 320) and various networks entities (350) in a hybrid wireless network (300). The hybrid network (300) implements a special mobile switching center (308) to be a “double agent” passing information between the mobile terminal (310 and 320) and entities (350) in its core network (302). In the context of messaging, the message contents may be encoded, packaged, and decoded appropriately. The present disclosure does not introduce any changes to telecommunication standards such as the GSM and CDMA standards governing the messaging process (304 and 306).

### BACKGROUND OF THE INVENTION

The present disclosure relates generally to voice and data communications, and more particularly, to a system and method for providing services to a wireless mobile terminal operating in a hybrid wireless network.

A typical wireless network is composed of two sub-networks: a Radio Access Network (RAN) which handles radio related issues such as assigning radio resources to a mobile terminal (or “mobile” in short) upon request for services, and a Core Network (CN) which links the mobile user to wireline networks. Current specifications of wireless networks require that the RAN and CN have the same wireless technology in order to provide wireless services. These networks may be referred to as “homogeneous networks.” For instance, a GSM mobile will only operate in a wireless network which its RAN and CN are both GSM wireless technology based. FIG. 1 illustrates a GSM wireless network 100 composed of a GSM RAN 102 and a GSM CN 104.

The GSM RAN 102 includes a GSM Mobile Station (MS) 106 that communicates to a GSM Base Station System (BSS) 108 through a GSM radio channel 110. The GSM BSS 108 includes a GSM Base Transceiver Station (BTS) 110 and GSM Base Station Controller (BSC) 112.

The GSM Core Network (CN) 104 includes a GSM Mobile Switching Center (MSC) 120 that is connected to the GSM BSC 112 as well as a GSM Gateway MSC (GMSC) 122 by using SS7 ISUP communications 124. The GSM GMSC 122 is also connected to the Public Switched Telephone Network (PSTN) 126 by using SS7 ISUP communications 124. In this figure, a telephone 128 is shown to be connected to the PSTN as an illustration of a calling/called party. In addition, a Serving General Packet Radio Service Node (GPRS) (SGSN) 130 is shown to also be connected to the GSM BSC 112. Moreover, a GSM Short Message Service Center (SMS-C) 132, a GSM Home Location Register (HLR) 134 and a GSM Authentication Center (AuC) 136 are all shown to be connected the GSM MSC 120 and the SGSN 130. Further, a GSM Service Control Point (SCP) 138 connects a GSM Billing System 140 to the GSM MSC 120 and the GSM HLR 134. The connection from the GSM Billing System 140 and the GSM MSC 120 utilizes IP. Additionally, a Packet Data Network (PDN) 142 is shown connected to the GSM CN 104 through a Gateway GPRS Node (GGSN) 144 utilizing IP communications.

A disadvantage of this configuration is that, given many wireless technologies that exist today and considering new ones being defined for the future, this is a serious limitation in the wireless service provision to deal with a situation in which a mobile compatible with one wireless technology moves into a wireless network of different technology. This prevents the mobile from getting services and limits the mobile's geographical service area to networks that support a specific wireless technology. The same limitation applies to wireless networks that are CDMA wireless technology based. FIG. 2 illustrates such a CDMA2000 based network 200.

The CDMA2000 RAN 201 includes a CDMA2000 MS 202 connected to a CDMA2000 BSS 204 through a CDMA2000 BTS 206. The CDMA2000 BTS 206 is in turn connected to a CDMA2000 BSC 208, which connects to a Packet Control Function (PCF) 210.

The CDMA2000 CN 212 connects to the CDMA2000 RAN 201 by the CDMA2000 BSC 208 connecting to the CDMA200 MSC 214. The CDMA2000 MSC 214 is connected to an IS-41 SMS-C 216, an IS-41 HLR 218, an IS-41 AuC 220 and an IS-41 SCP 222. The IS-41 SCP 222 in turn is also connected to the IS-41 HLR 218 and a Store and Forward Service 224, which in turn is connected to an IS-41 Billing System 226. In addition, a Packet Data Serving Node (PDSN) 228 is connected to the PCF 210 of the CDMA2000 RAN 200 and a PDN 230. Moreover, the CDMA2000 MSC 214 connects the CDMA2000 CN 212 to the PSTN 232 and a phone 234.

A hybrid wireless network is a wireless network composed of a RAN and a CN of different technologies linked. FIG. 3 illustrates such a hybrid wireless network 300 including a GSM CN 302, which may be in communication with a GSM RAN 304 and/or a CDMA RAN 306. The RAN 304 and 306 communicate with the CN 302 through a Hybrid Mobile Switching Center (HMSC) 308. A detailed description thereof can be found in co-pending patent application Ser. No. ______, which was filed on ______ and entitled “Method and System for Providing Wireless Services in a Composite Wireless Network Comprising at Least One Access Network and One Core Network of Different Technologies.” This network architecture presents a large advantage in deployment speed and cost reduction over the traditional homogeneous wireless networks discussed previously. One of the problems solved is to enable a mobile terminal in one of the RANs 304 or 306 and certain network entities in the CN 302 to exchange message contents without being obstructed by the differences in the technologies involved (e.g., message encoding and decoding schemes).

For example, in most wireless networks, wireless services are granted to a mobile after it is authenticated. This process is known as the authentication of a mobile. Different wireless technologies use different procedures and algorithms to perform such an authentication process. For instance, a CDMA mobile operating in a CDMA network generates authentication parameters which are quite different from those generated by a GSM mobile operating in a GSM network. There are currently no known solutions to provide authentication of a mobile operating in a hybrid wireless network.

Another problem is exchanging short message service (SMS) between different networks. Turning back to FIG. 1, the SMS message is typically encoded using a special encoding scheme before it is transmitted over a radio link 110. The mobile is capable of encoding the SMS message before it is sent to the network and decoding after receiving it from the network. The encoding and decoding actions are usually performed at the mobile and a Short Message Service Center (SMS-C) 132 located in the CN 104. Different coding schemes are typically used in different wireless technologies. For instance, the encoding and decoding schemes of SMS messages in the CDMA network are different from the ones used in the GSM network. Therefore, in hybrid networks, the encoding and decoding schemes of the SMS message are different at the mobile and the SMS-C. This leads to a major problem given that the decoder at one end cannot understand the encoding scheme used at the message generation end, and therefore, the SMS service cannot be provided.

What is needed, therefore, is a method and system for providing a solution to pass information and parameters to and from a mobile in a hybrid wireless network.

### SUMMARY OF THE INVENTION

Embodiments of a method and system are disclosed to pass information or message contents between a mobile terminal and various networks entities in a hybrid wireless network. One embodiment includes a hybrid wireless network having at least one radio access network (RAN) based on a first technology and a core network (CN) based on a second technology. The hybrid network uses a special Mobile Switching Center to be a “double agent” passing information between the mobile terminal and entities in the CN. In the context of messaging, the message contents may be encoded, packaged, and decoded appropriately.

In one example embodiment, a method and system is disclosed for providing authentication of a mobile terminal in a hybrid wireless network, the hybrid wireless network having at least one radio access network (RAN) based on a first technology and a core network (CN) based on a second technology. When the mobile terminal from the RAN requests a registration, the CN passes predetermined parameters for the authentication to the mobile terminal through a hybrid mobile switching center (HMSC) using messages conforming to the first technology. The passed parameters conforms to the second technology. With these parameters, an authentication process is invoked by the mobile terminal. The result of the authentication is sent out to the HMSC of the CN. The HMSC is capable of communicating to both the mobile terminal and the CN with messages conforming to either the first or second technologies.

In another example embodiment, a method and system is provided to perform mobile authentication in a hybrid wireless network composed of a CDMA RAN and a GSM CN. Effectively, the present disclosure provides a method and procedure to send GSM information from the GSM CN to the mobile in the CDMA RAN, and from the mobile in the CDMA RAN back to the GSM CN through a Hybrid Mobile Switching Center (HMSC). For example, IS-41 DTAP messages are used to transfer GSM information from the HMSC to the mobile and from the mobile to the HMSC. Furthermore, CDMA messages parameters are mapped into GSM messages parameters.

In yet another example embodiment, a method and system is disclosed for transmitting message contents in a hybrid wireless network, the hybrid wireless network having at least one radio access network (RAN) based on a first technology and a core network (CN) based on a second technology, and the RAN and CN having different encoding and decoding schemes for the message contents. The predetermined message contents are sent in a message of a first type from a network entity in the CN to a Hybrid Mobile Switching Center (HMSC) using a first encoding scheme. The HMSC extracts the encoded message contents, and packages the extracted message content in a second message of a second type readable by a mobile terminal in the RAN. The mobile terminal extracts the message contents from the second message, and decodes the message contents encoded by the first encoding scheme. The HMSC is capable of communicating to both the mobile terminal and the CN with messages conforming to either the first or second technologies and wherein the mobile terminal is a dual mode terminal operable with either the first or the second technologies.

Similarly, for communications initiated by the mobile terminal, an embodiment of method and system is disclosed for transmitting message contents in a hybrid wireless network, the hybrid wireless network having at least one radio access network (RAN) based on a first technology and a core network (CN) based on a second technology, the RAN and CN having different encoding and decoding schemes for the message contents. When the message contents are sent in a message of a first type from a mobile terminal in the RAN to a Hybrid Mobile Switching Center (HMSC) in the CN using a first encoding scheme, the HMSC extracts the encoded message contents, packages the extracted message content in a second message of a second type readable by a predetermined network entity in the CN. The message contents from the second message are extracted by the network entity, and decoded accordingly using the first encoding scheme, wherein the HMSC is capable of communicating to both the mobile terminal and the CN with messages conforming to either the first or second technologies and wherein the mobile terminal is a dual mode terminal operable with either the first or the second technologies.

Henceforth, the present disclosure presents a solution to deploy a new radio technology into wireless networks without introducing any change to the core network. This creates a huge advantage for network operators that looking to expand their wireless service coverage of a new radio technology. The present disclosure needs very low cost and short deployment time considering that the core network does not have to be changed whatsoever. By deploying a new radio technology over an existing core network of existing technologies, major advantages are achieved at the radio access network such as higher bit rates. Other advantages are higher network capacity and increase in spectrum efficiency on the radio which leads to the ability of supporting larger number of subscribers and introducing better quality of service to the mobile user end. This means providing larger service coverage area and higher revenues to network operators.

### BRIEF DESCRIPTION OF THE DRAWINGS

FIG. 1 illustrates a GSM wireless network architecture for providing services to a mobile terminal.

FIG. 2 illustrates a CDMA wireless network architecture for providing services to a mobile terminal.

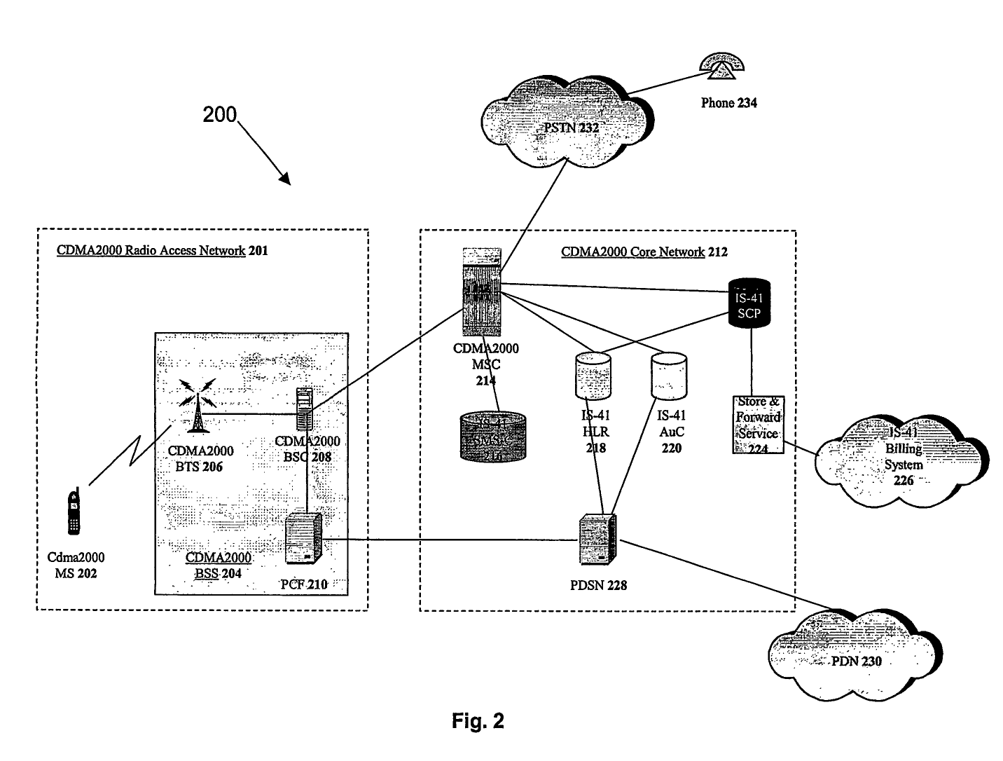

FIG. 3 illustrates a hybrid wireless network architecture with a Hybrid Mobile Switching Center and utilizing the CDMA wireless technology in the RAN and GSM wireless technology in the CN according to one example of the present disclosure.

FIG. 4 illustrates a call flow diagram to perform the authentication of a mobile in a CDMA/GSM hybrid wireless network according to one example of the present disclosure.

FIG. 5 illustrates a call flow diagram to deliver SMS message from a GSM SMS-C to a bile in a hybrid network according to one example of the present disclosure.

FIG. 6 illustrates a call flow diagram to deliver SMS message from a mobile to a GSM SMS-C in a hybrid network according to one example of the present disclosure.

### DESCRIPTION OF THE PREFERRED EMBODIMENT

For the purposes of the present disclosure, various acronyms are used, and the definitions of which are listed below:
ANSI41 American National Standards Institute—Cellular Radio Telecommunications Intersystem Operations.
AuC Authentication Centre—a permanent database server used in mobile systems to identify a subscriber and to contain subscriber data related to features and services.
BSC Base Station Centre
BSS Base Station System
BTS Base station Transceiver System
CN Core Network
GGSN Gateway GPRS Support Node
GMSC Gateway Mobile Switching Centre—a means to route a mobile station call to the MSC containing the called party's Home Location Register.
GPRS General Packet Radio Service—a service designed for GSM digital cellular networks to support transmission of intermittent and bursty data transfers as well as occasional transmission of large volumes of data. The most common application of GPRS is expected to be Internet/intranet access.
GSM Global System for Mobile communications
HLR Home Location Register—a permanent SS7 database used in cellular networks.
IP Internet Protocol
IS41 Wireless Network conforming to the IS41 standard
ISDN Integrated Services Digital Network
ISUP ISDN User Part (of SS7)
Ki Subscriber authentication key
MSC Mobile Switching Centre
PDN Public Data Network—a public network for the transmission of data, particularly a network compatible with X.25 protocol.
PCF Packet Carrying Function—formerly called an InterWorking Function or IWF
PSTN Public Switch Telephone Network
RAN Radio Access Network
SCP Signal Control Point—a remote database within a System Signaling 7 network to supply translation and routing data needed to deliver advanced network services.
SMS Short Message Service—short text messages exchanged between mobile telephones and other networks.
SMS-C Short Message Service Centre—the entity that stores and forwards Short Message Service (“SMS”) messages.
SRES Signed RESponses
SS7 Signaling System No.7
T1 Digital communication line that uses time division multiplexing with an overall transmission rate of 1.544 million bits per second.
TCP/IP Transmission Control Protocol/Internet Protocol

The present disclosure provides several examples below, and it is understood that the examples are not necessarily limitations to the present invention, but are used to describe embodiments of the method and system of the present invention. The general concept is to pass information or message contents between a mobile terminal and various networks entities in a hybrid wireless network. The hybrid network implements a special mobile switching center to be a “double agent” passing information between the mobile terminal and entities in the CN. In the context of messaging, the message contents may be encoded, packaged, and decoded appropriately.

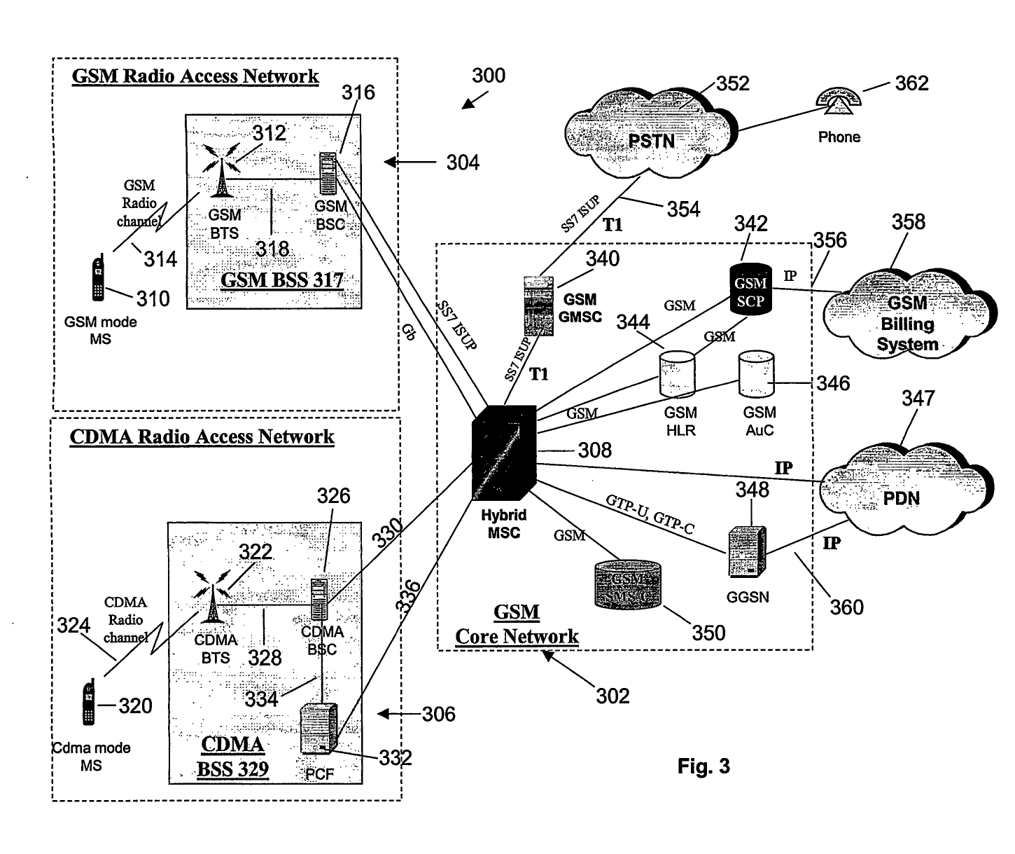

FIG. 3 illustrates a wireless network architecture utilizing a Hybrid Mobile Switching Center (HMSC) 308 to connect a CDMA RAN 306 and a GSM RAN 304 to the GSM CN 302. In this example, the HMSC 308 has a centralized call control model for voice and packet data calls. This module allows the HMSC 308 to handle and keep track of all calls for a given mobile phone. In contrast, in a traditional GSM MSC or a CDMA MSC the call control for data and voice are located in different network entities. In this example embodiment, setting-up and controlling a voice or a data call for a mobile user is performed at the HMSC 308.

The example network architecture shown in FIG. 3 illustrates a hybrid network utilizing certain aspects of the present invention. The illustrative network provides both voice and packet data services to mobile stations in either of the two networks. For instance, in the GSM RAN 304, a GSM mobile unit 310 communicates with a GSM BTS 312 over a GSM radio link 314. The GSM BTS 312 typically communicates with a GSM BSC 316 using a wired link 318. The BTS 312 and BSC 316 comprise a base station system or BSS 317. In the illustrative embodiments, the HMSC 308 communicates with the GSM BSC 316 over a voice link using an SS7 ISUP protocol and over a data link using a Gb protocol.

Similarly, in the CDMA RAN 306, a CDMA 2000 mobile phone 320 communicates with a CDMA BTS 322 over a CDMA radio link 324. The CDMA BTS 322 typically communicates with a CDMA BSC 326 using a proprietary wired link 328. Typically, for voice communications, the CDMA BSC 326 communicates with the HMSC 308 over a link 330 using a variety of protocols, including A1, A2, A5, A8, and A9. The CDMA BSC 326 transfers data to a PCF 332 over a link 334 using A8 and A9 protocols. Thus, data is usually sent by the PCF 332 to the HMSC 308 over a link 336 using the A10 and A11 protocols.

If the core network is a GSM network, as in the illustrative network 300, the HMSC 308 communicates with the other GSM network components in much the same way a typical MSC would communicate with the GSM network components. For instance, the HMSC 308 may establish links with a GMSC 340, a SCP 342, an HLR 344, a AuC 346, a PDN 347, a GGSN 348, and/or a SMS-C 350. Similarly, the GMSC 340 may communicate with a PSTN 352 through a T1 link 354 using a SS7 ISUP protocol. The SCP 342 may establish a link 356 with a billing system 358, and the GGSN 348 may establish a link 360 with the PDN 347, where the links 356 and 360 uses an IP protocol. Thus, for each connection, FIG. 3 illustrates an example link and the corresponding communication protocol used to allow communication between typical network entities. As those skilled in the art would recognize, similar communication links may be established if the CN 302 were a CDMA network.

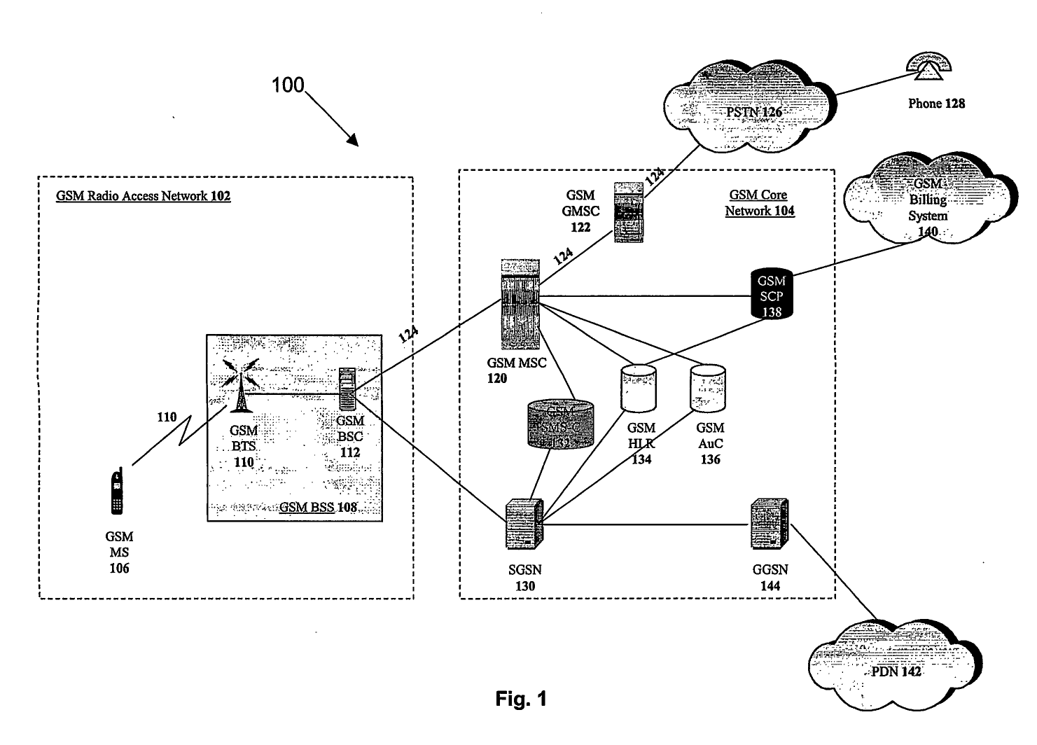

Thus, for calls established with the GSM mobile 310, the HMSC 308 acts like a GSM MSC 110 as depicted in FIG. 1. For calls established with the CMDA2000 mobile 320, the HMSC 308 links the CDMA RAN 304 to the GSM CN 302 by translating and mapping CDMA RAN messages initiated in the RAN 304 into GSM CN messages sent to the CN 302, and GSM messages initiated by the CN 302 into CDMA messages sent to the RAN 306.

The HMSC 308 can support voice and packet data call services from mobiles in any type of RAN to any other type of network. For instance the mobile 310 in the GSM RAN 304 can make a call to another mobile (not shown) operating in the CDMA RAN 306, a telephone 362 connected to the PSTN 352, or an entity as part of the PDN 347 and other networks that are not illustrated nor discussed in this disclosure for reasons of simplicity and clarity. The HMSC 308 is shown in communication with two RANs of different technologies, however as would be clear to one skilled in the art, the present invention also applies in situations where the HMSC 308 is in communication with one or more RANs of same technology.

Wireless services are granted to a mobile phone after the mobile phone is “authenticated.” Different wireless technologies use different procedures and algorithms to perform such an authentication process. For instance, the GSM mobile phone 310 operating in the GSM RAN 304 generates authentication parameters which are different from those generated by the CDMA mobile phone 320 operating in the CDMA RAN 306. Thus, one aspect of the present invention solves this problem by providing for a method of authentication of a mobile terminal in a hybrid wireless network, the hybrid wireless network having at least one radio access network (RAN) based on a first technology (e.g. CDMA) and a core network (CN) based on a second technology (e.g., GSM). Generally, the method comprises: requesting a registration of the mobile terminal from the RAN; passing predetermined parameters for the authentication by the CN through a HMSC to the mobile terminal using messages conforming to the first technology, the parameters conforming to the second technology; invoking an authentication process by the mobile terminal using the passed parameters; and informing the HMSC of the CN for the authentication of the mobile terminal.

As is known in the art, a GSM authentication checks the validity of the subscriber's SIM card and then decides whether the mobile station should be allowed on a particular network. In a typical GSM network, the authentication process begins when a BSS/MSC/VLR sends the RAND and a GSM Cipering Key sequence (“Kc”), to the mobile unit. The mobile unit uses the RAND and its own Ki to generate a SRES, which is then sent back to the BSS/MSC/VLR. The BSS/MSC/VLR compares the value of SRES received from the AuC with the value of SRES it has received from the mobile station. If the two values of SRES match, authentication is successful and the subscriber joins the network.

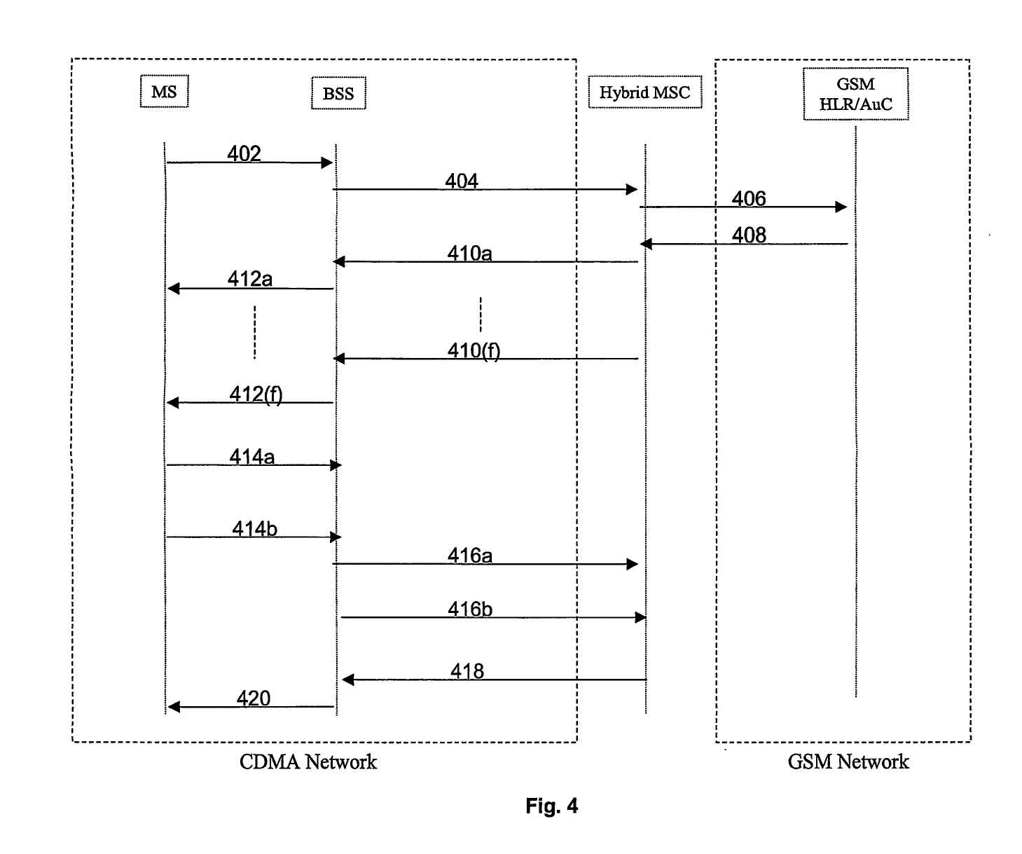

FIG. 4 illustrates an example call flow diagram for an authentication process in a hybrid network using certain aspects of the present invention. In this example, the CDMA mobile phone 320 is in the hybrid network 300 composed of the CDMA RAN 306 and the GSM CN 302 (FIG. 3). Because the CN is a GSM network, the registration parameters that are passed through the CDMA RAN 306 are GSM parameters. The mobile phone 320 sends a registration a registration message 402 to the BSS 329 and then waits for the response from the network in the form of a Registration_Accept message.

When the BSS 329 receives the registration message 402, the BSS 329 sends a DTAP: Location Updating Request 404 to the HMSC 308. In response, the HMSC 308 transforms the DTAP: Location Updating Request 404 to a security related information request 406, which requests security related information from the HLR/AuC corresponding to the mobile station. Upon receiving the expected authentication information, the AuC 346 retrieves a Subscriber authentication key (“Ki”) from its database. The AuC 346 and the HLR 344 generate a random value (“RAND”), and using the Ki, computes a Signed RESponses (“SRES”). In step 408, the HLR/AuC sends an Authentication Vector Response 408 to the HMSC 308. The parameters contained in the response 408 include, a RAND, SRES, and a Cipering Key sequence (“Kc”). The HMSC 308 stores these parameters.

In this embodiment, the RAND and the Kc are passed back to the mobile unit 320 so that the mobile unit can generate its own SRES. The parameters are to be transparent to all entities in the CDMA RAN 306 except the mobile unit 320. In other words, none of the entities in the RAN 306 are supposed to read or act upon the parameters, except for simply forwarding them to the next entity until the destination is reached.

In the present disclosure, a DTAP message is used because all DTAP messages are transparent to the entities in the RAN between the mobile and the HMSC. In the illustrative example, the CDMA DTAP message used is an “Authentication_Request.” However, according the CDMA standard, this message cannot hold more than 3 bytes of data for parameters. However, the RAND has a length of 16 bytes and Kc has a length of ½ byte. Consequently, a total of 16 and ½ bytes of space is required in a CDMA message to pass these parameters to the mobile unit 320. Therefore, 6 subsequent messages are used to transfer all the GSM parameters to the mobile. Thus, a DTAP: Authentication_Request 410a message is sent from the HMSC 308 to the BSS 329. In response the BSS 329 passes these parameters to the mobile unit 320 in the form of an Authentication Challenge 412f. This process is repeated six times until the DTAP: Authentication_Request 410f message is received by the BSS 329, which in response sends an Authentication Challenge 412f to the mobile unit. When the mobile unit 320 receives the message 412a, it reassembles the segmented GSM parameters. Given that the mobile is a dual mode one, it uses RAND and Kc as input parameters to its GSM authentication algorithm which will generate its own GSM “Authentication Response parameter” or SRES. As explained previously, this parameter is normally uploaded back to the typical GSM network where it is compared with an SRES value generated by the network using RAND and Kc, and thereby confirming that the mobile is authentic. Thus, the SRES value generated by the mobile unit 320 is sent back to the Hybrid MSC 308 for verification. The SRES parameter has a total length of 4 bytes. The Authentication Challenge Response message, which may be used to pass the SRES parameter to the HMSC has 2 free bytes. Thus, the SRES parameter may be split over an Authentication Challenge Response message 414a and a Authentication Challenge Response message 414b, which are sent by the mobile unit 320 to the BSS 329. In response, the BSS 329 forwards the parameter to the HMSC 308 over two DTAP: Authentication Response messages 416a and 416b. When the HMSC 308 receives the messages 416a and 416b, it reassembles the segmented SRES and compares this value to the SRES value it generated to authenticate the mobile unit 320. If the values are the same, the HMSC 308 authenticates the mobile unit 320.

After authenticating the mobile, the HMSC 308 replies with a CDMA “Location Update accept” message 418 which is sent to the BSS 329. The BSS 329 translates the message 418 into a “Registration Accept” message 420 and sends message 420 to the mobile unit 320. The mobile unit 320 now can have service and make calls.

The above disclosure provides many different embodiments, or examples, for implementing the disclosure. However, specific examples, and processes are described to help clarify the disclosure. These are, of course, merely examples and are not intended to limit the disclosure from that described in the claims. For instance, even if a sample registration message and procedure is used to describe the disclosure, the present disclosure still applies to any scenario or event that can occur in the wireless network and that causes the mobile or the network to initiate the authentication procedure. For instance, in the illustrative example, the DTAP message “Authentication Request” is used to transfer GSM information on the downlink. However, the present invention is equally applicable to any DTAP message currently specified or will be specified in the standards that can be used between the mobile and the HMSC. Similarly, the illustrative example uses an “Authentication Response” to transfer GSM information on the uplink. However, the present embodiment applies to any DTAP message currently specified or will be specified in the standards that can be used between the mobile and the HMSC. Similarly, even though certain message fields have been specifically discussed to carry the GSM information in the example embodiment, the present invention is equally applicable to any field or set of fields that are transparent to the network entities between the mobile and the HMSC.

Furthermore, the above-described method for implementing an authentication service is only used as an example. The method is equally applicable to message contents that are encoded using different coding schemes between the RAN and the CN. For instance, referring back to FIG. 1, an SMS service provisioned in a traditional network requires that the SMS-C and the mobile to use the same encoding scheme to encode an SMS message before sending it to each other and the same decoding scheme to extract the message once they receive it. For hybrid networks, the traditional method of encoding/decoding SMS will not work given that the encoding and decoding schemes at the mobile and SMS-C are not the same due to different technologies used in the RAN and CN.

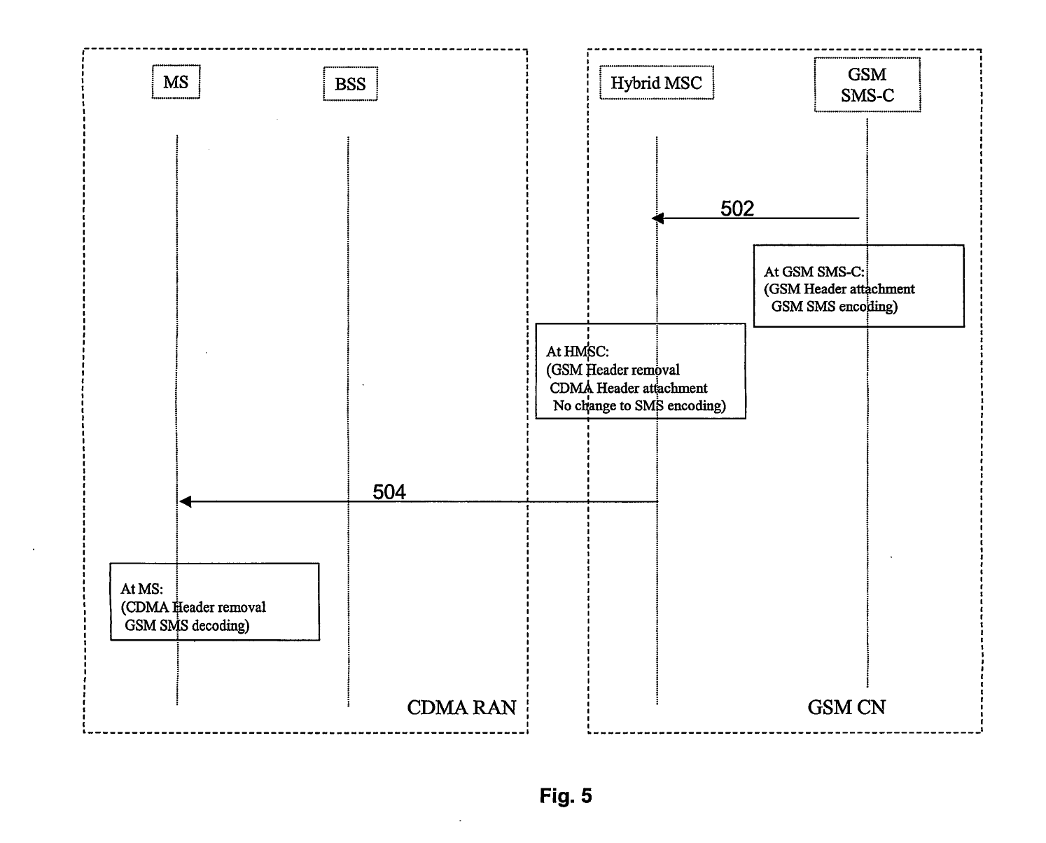

Turning now to FIG. 5, there is illustrated one embodiment of a method for transmitting SMS messages in the hybrid network 300 with the GSM CN 302 and CDMA RAN 306. The GSM SMS-C 350 of the CN 302 uses GSM coding schemes to create a SMS message 502, which is sent to the HMSC 308. As is typical with SMS messages, the message 502 has a header part and a payload part. The encoding scheme is sent as the payload part. Once the SMS message 502 is received, the HMSC 308 extracts the SMS payload. The SMS payload may then be inserted into a CDMA DTAP message 504. The DTAP message 504 has a CDMA header, but the payload is the same as the SMS message 502. Thus, there is no change to the SMS encoding. The DTAP message 504 may then be sent to the mobile unit 320 through the BSS 329. Given that the DTAP messages are transparent to the RAN 306, no entity in the RAN will access the SMS payload except the mobile unit 320. The mobile unit 320 may then use a GSM decoding scheme to extract and decode the GSM SMS encoding carried in the DTAP message with a CDMA header.

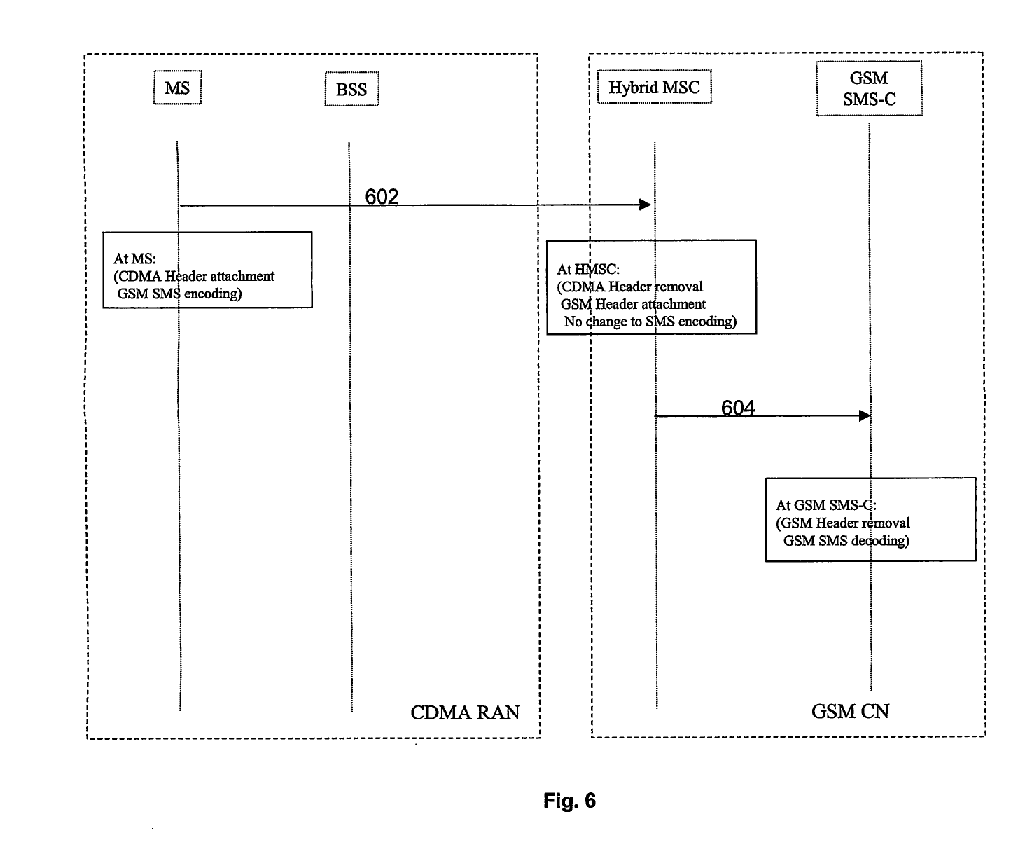

An alternative embodiment is illustrated in FIG. 6, which shows a call flow diagram where the mobile unit 320 uses a GSM encoding scheme to send SMS messages within CDMA DTAP messages. The mobile unit 320 is aware of what network it is operating in, e.g., a GSM network, CDMA network or a Hybrid Network. In case of a hybrid network, the mobile unit 320 uses a GSM SMS encoder to generate and sends a DTAP message 602 to the HMSC 308 via the BSS 329. The DTAP message 602 has a CDMA header and a payload containing the SMS. Given that the DTAP messages are transparent to the RAIN 306, no entity in the RAN will access the SMS payload. When the HMSC 308 receives the message 602, the HMSC removes the header and extracts the encoding message contents from the payload of the DTAP message 602 and packages the contents within a new SMS message 604 containing a GSM header and a GSM encoding scheme. The SMS message 604 is then sent to the GSM SMS-C 350. The GSM SMS-C 350 removes the header and uses a GSM decoder to extract and decode the SMS messages received.

Although a general switching system is used to describe the HMSC, the present disclosure is applicable to any switching system that may include one or more network entities which have various call control systems. Such a switching system may serve one or more RANs of different technologies as well as RANs sharing the same technology. The switching system may also link the RANs of various technologies to a CN of a predetermined wireless technology. For instance, a soft switch technology can be used to implement the HMSC which may include two parts each implemented in an independent network entity. One of the two network entities may handle the control part of a call and the other network entity may handle the bearer part. Using soft switch technology to implement the HMSC, the present disclosure provides a maximum leverage of equipment investment since the network configuration becomes highly scalable.

Additionally, although a dual-mode mobile that can support voice and packet data is used to describe the disclosure, the present invention is applicable to any multi-mode mobile. Additionally, GSM and CDMA are used as examples to describe the disclosure. It is understood that the disclosure still applies to any authentication scenario between two wireless networks that have the same CN technology but different RAN technologies.

Furthermore, even though the CDMA and GSM technologies are used to describe the disclosure, the present disclosure applies to any wireless technology that can be used in a hybrid wireless network, not limited to these two particular technologies.

The present disclosure as described above thus provides an economical method and system for providing an authentication solution to a multi-mode mobile operating in a hybrid network. The present disclosure does not introduce any changes to the GSM and CDMA standards that define the protocols used to communicate between all network entities. Also, the disclosure does not introduce any change to any entity between the HMSC and the mobile.

In addition, the present disclosure provides a cost effective solution given that it does not introduce any change to existing architectures in the RAN and CN. This is a significant advantage for a network operator or service provider because there is no need for investing capital in upgrading existing equipment. The migration of the services to be supported by the new network can be achieved in a much shorter time and at a lower cost. The method and system described in the present disclosure increases the wireless coverage to operators exponentially, speeds up deployment phase, minimizes deployment expenses, eliminates core network operation expenses and provides higher quality of service for the mobile end user, therefore attracting more subscribers to operators.

Also, the present disclosure presents a solution to deploy a new radio technology into wireless networks without introducing any change to the core network. This creates a huge advantage for network operators that looking to expand their wireless service coverage of a new radio technology. The present disclosure needs very low cost and short deployment time considering that the core network does not have to be changed whatsoever. By deploying a new radio technology over an existing core network of existing technologies, major advantages are achieved at the radio access network such as higher bit rates. Other advantages are higher network capacity and increase in spectrum efficiency on the radio which leads to the ability of supporting larger number of subscribers and introducing better quality of service to the mobile user end. This means providing larger service coverage area and higher revenues to network operators.

Moreover, because no changes are made to the existing core network, the present disclosure allows the delivery of all existing CN services to any mobile in its serving area.

It will also be understood by those skilled in the art that one or more (including all) of the elements/steps of the present disclosure may be implemented using software and hardware to develop the HMSC, which will then be deployed in a wireless network at appropriate locations with the proper connections. Furthermore, while the disclosure has been particularly shown and described with reference to the preferred embodiment thereof, it will be understood by those skilled in the art that various changes in form and detail may be made therein without departing from the spirit and scope of the disclosure, as set forth in the following claims.

1. A method for transmitting message contents in a hybrid wireless network, the hybrid wireless network having at least one radio access network (RAN) based on a first technology and a core network (CN) based on a second technology, the RAN and CN having different encoding and decoding schemes for the message contents, the method comprising:
sending message contents in a message of a first type from a network entity in the CN to a Hybrid Mobile Switching Center (HMSC) using a first encoding scheme;
extracting the encoded message contents by the HMSC;
packaging the extracted message content in a second message of a second type readable by a mobile terminal in the RAN;
extracting the message contents from the second message by the mobile terminal; and
decoding the message contents encoded by the first encoding scheme,
wherein the HMSC is capable of communicating to both the mobile terminal and the CN with messages conforming to either the first or second technologies and wherein the mobile terminal is a dual mode terminal operable with either the first or the second technologies.

2. The method of claim 1 wherein the CN is a GSM based network and the RAN is a CDMA based network.

3. The method of claim 1 wherein the CN is a CDMA based network and the RAN is a GSM based network.

4. The method of claim 1 wherein the wireless mobile terminal is a multi-mode terminal operable with both the first and second technologies.

5. The method of claim 1 wherein the encoding scheme is a Short Message Service (SMS) encoding scheme.

6. The method of claim 1 wherein at least one of the messages comprises a header and a payload.

7. A method for transmitting message contents in a hybrid wireless network, the hybrid wireless network having at least one radio access network (RAN) based on a first technology and a core network (CN) based on a second technology, the RAN and CN having different encoding and decoding schemes for the message contents, the method comprising:
sending message contents in a message of a first type from a mobile terminal in the RAN to a Hybrid Mobile Switching Center (HMSC) in the CN using a first encoding scheme;
extracting the encoded message contents by the HMSC;
packaging the extracted message content in a second message of a second type readable by a predetermined network entity in the CN;
extracting the message contents from the second message by the network entity; and
decoding the message contents encoded by the first encoding scheme,
wherein the HMSC is capable of communicating to both the mobile terminal and the CN with messages conforming to either the first or second technologies and wherein the mobile terminal is a dual mode terminal operable with either the first or the second technologies.

8. The method of claim 7 wherein the CN is a GSM based network and the RAN is a CDMA based network.

9. The method of claim 7 wherein the CN is a CDMA based network and the RAN is a GSM based network.

10. The method of claim 7 wherein the wireless mobile terminal is a multi-mode terminal operable with both the first and second technologies.

11. The method of claim 7 wherein the encoding scheme is a Short Message Service (SMS) encoding scheme.

12. The method of claim 7 wherein at least one of the messages comprises a header and a payload.

13. A method for providing authentication of a mobile terminal in a hybrid wireless network, the hybrid wireless network having at least one radio access network (RAN) based on a first technology and a core network (CN) based on a second technology, the method comprising:
requesting a registration of the mobile terminal from the RAN;
passing predetermined parameters for the authentication by the CN through a hybrid mobile switching center (HMSC) to the mobile terminal using messages conforming to the first technology, the parameters conforming to the second technology;
invoking an authentication process by the mobile terminal using the passed parameters; and
informing the HMSC of the CN for the authentication of the mobile terminal,
wherein the HMSC is capable of communicating to both the mobile terminal and the CN with messages conforming to either the first or second technologies.

14. The method of claim 13 wherein the CN is a GSM based network and the RAN is a CDMA based network.

15. The method of claim 13 wherein the CN is a CDMA based network and the RAN is a GSM based network.

16. The method of claim 13 wherein the wireless mobile terminal is a multi-mode terminal operable with both the first and second technologies.

17. The method of claim 13 wherein the predetermined parameters sent to the mobile comprise a random number (RAND) and a ciphering key.

18. The method of claim 17 wherein the invoking comprises generating a first Signed RESponses (SRES) from the RAND and a Subscriber authentication key (Ki).

19. The method of claim 18 further comprising generating a second SRES from the RAND and the ciphering key.

20. The method of claim 19 further comprising comparing the first SRES to the Second SRES to complete the authentication process.

21. A system for transmitting message contents in a hybrid wireless network, the hybrid wireless network having at least one radio access network (RAN) based on a first technology and a core network (CN) based on a second technology, the RAN and CN having different encoding and decoding schemes for the message contents, the system comprising:
a means for sending message contents in a message of a first type from a network entity in the CN to a Hybrid Mobile Switching Center (HMSC) using a first encoding scheme;
a means for extracting the encoded message contents by the HMSC;
a means for packaging the extracted message content in a second message of a second type readable by a mobile terminal in the RAN;
a means for extracting the message contents from the second message by the mobile terminal; and
a means for decoding the message contents encoded by the first encoding scheme,
wherein the HMSC is capable of communicating to both the mobile terminal and the CN with messages conforming to either the first or second technologies and wherein the mobile terminal is a dual mode terminal operable with either the first or the second technologies.

22. The system of claim 21 wherein the CN is a GSM based network and the RAN is a CDMA based network.

23. The system of claim 21 wherein the CN is a CDMA based network and the RAN is a GSM based network.

24. The system of claim 21 wherein the wireless mobile terminal is a multi-mode terminal operable with both the first and second technologies.

25. The system of claim 21 wherein the encoding scheme is a Short Message Service (SMS) encoding scheme.

26. The system of claim 21 wherein at least one of the messages comprises a header and a payload.

27. A system for transmitting message contents in a hybrid wireless network, the hybrid wireless network having at least one radio access network (RAN) based on a first technology and a core network (CN) based on a second technology, the RAN and CN having different encoding and decoding schemes for the message contents, the system comprising:
a means for sending message contents in a message of a first type from a mobile terminal in the RAN to a Hybrid Mobile Switching Center (HMSC) in the CN using a first encoding scheme;
a means for extracting the encoded message contents by the HMSC;
a means for packaging the extracted message content in a second message of a second type readable by a predetermined network entity in the CN;
a means for extracting the message contents from the second message by the network entity; and
a means for decoding the message contents encoded by the first encoding scheme,
wherein the HMSC is capable of communicating to both the mobile terminal and the CN with messages conforming to either the first or second technologies and wherein the mobile terminal is a dual mode terminal operable with either the first or the second technologies.

28. The system of claim 27 wherein the CN is a GSM based network and the RAN is a CDMA based network.

29. The system of claim 27 wherein the CN is a CDMA based network and the RAN is a GSM based network.

30. The system of claim 27 wherein the wireless mobile terminal is a multi-mode terminal operable with both the first and second technologies.

31. The system of claim 27 wherein the encoding scheme is a Short Message Service (SMS) encoding scheme.

32. The system of claim 27 wherein at least one of the messages comprises a header and a payload.

33. A system for providing authentication of a mobile terminal in a hybrid wireless network, the hybrid wireless network having at least one radio access network (RAN) based on a first technology and a core network (CN) based on a second technology, the system comprising:
a means for requesting a registration of the mobile terminal from the RAN;
a means for passing predetermined parameters for the authentication by the CN through a hybrid mobile switching center (HMSC) to the mobile terminal using messages conforming to the first technology, the parameters conforming to the second technology;
a means for invoking an authentication process by the mobile terminal using the passed parameters; and
a means for informing the HMSC of the CN for the authentication of the mobile terminal,
wherein the HMSC is capable of communicating to both the mobile terminal and the CN with messages conforming to either the first or second technologies.

34. The system of claim 33 wherein the CN is a GSM based network and the RAN is a CDMA based network.

35. The system of claim 33 wherein the CN is a CDMA based network and the RAN is a GSM based network.

36. The system of claim 33 wherein the wireless mobile terminal is a multi-mode terminal operable with both the first and second technologies.

37. The system of claim 33 wherein the encoding scheme is a Short Message Service (SMS) encoding scheme.
